(19) United States
(12) Patent Application Publication
(10) Pub. No.: US 2026/0210709 A1
(43) Pub. Date: Jul. 23, 2026

(54) LASER RANGEFINDER WITH AUTOMATED RANGING MODE FEATURES

(71) Applicant: LEUPOLD & STEVENS, INC., Beaverton, OR (US)

(72) Inventors: Eric Tyler OVERSTREET, Lake Oswego, OR (US); Victoria J. PETERS, Vernonia, OR (US)

(21) Appl. No.: 19/452,101

(22) Filed: Jan. 16, 2026

Related U.S. Application Data
(60) Provisional application No. 63/746,843, filed on Jan. 17, 2025.

(51) Int. Cl. G01C 3/02

(52) U.S. Cl. CPC G01C 3/02

(57) ABSTRACT

Various embodiments described herein may include a laser rangefinder including a module operable in more than one ranging mode of operation, to determine a range to a target in an environment; and circuitry configured to: obtain information indicative of a current environmental condition corresponding to the laser rangefinder (e.g., a humidity, temperature, or pressure sensor data); detect, based on the obtained information, an exception, wherein the exception comprises a current ranging mode of operation of the ranging modes of operation being non-coincident with the current environmental condition; and control the module to automatically switch to a coinciding ranging mode of operation of the ranging modes of operation. Other embodiments may be disclosed and/or claimed.

### PRIORITY

This application is a non-provisional of U.S. Provisional Application Ser. No. 63/746,843, filed on Jan. 17, 2025, which is incorporated by reference herein.

### TECHNICAL FIELD

The field of the present disclosure relates generally to laser rangefinders, and more particularly to a laser rangefinder that may utilize onboard sensors and/or its external interface to obtain data indicative of environmental conditions, to automatically select a coinciding ranging mode of operation from a group of more than one ranging mode of operation.

### BACKGROUND

Some known laser rangefinders feature user-selectable ranging modes of operation to optimize ranging performance in different conditions. For example, in foggy or dusty conditions, the laser rangefinder may produce false readings if not set in a last target ranging mode.

Known laser rangefinders may require watching a display on the laser rangefinder, while operating a user input interface of the laser rangefinder to change a current ranging mode of operation. For example, when encountering fogging conditions, while watching a display on the laser rangefinder, the operator may decide whether or not to utilize last target ranging mode. While continuing to watch the display, the user may operate the user input interface (e.g., navigate through a menu to a desired ranging mode of operating, and enabling it) to then set the laser rangefinder to last target ranging mode. When those fogging conditions are no longer present, the operator perform a similar process to set the laser rangefinder back to a general ranging mode of operation.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 is a schematic diagram of a system including a laser rangefinder with automatic ranging mode features, according to various embodiments.

FIG. 2A is an example of a display provided by the laser rangefinder of FIG. 1, when a current ranging mode of ranging modes of operation of the laser rangefinder is set to a last target ranging mode.

FIG. 2B is an example of a display provided by the laser rangefinder of FIG. 1, when a current ranging mode of ranging modes of operation of the laser rangefinder is set to a general ranging mode.

FIG. 3 is a flow chart illustrating operations that may be performed by any laser rangefinder described herein, according to various embodiments.

FIG. 4 is a flow chart illustrating operations that may be performed by any laser rangefinder described herein, according to various embodiments.

### DETAILED DESCRIPTION

With reference to the drawings, this section describes particular embodiments and their detailed construction and operation. Throughout the specification, reference to “one embodiment,” “an embodiment,” or “some embodiments” means that a particular described feature, structure, or characteristic may be included in at least one embodiment. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

Some laser rangefinders may have a group of more than user-selectable ranging mode of operation. A non-exhaustive list of different ranging modes of operation is provided below:
Last target ranging mode of operation (also called “fog mode”)—in foggy and/or dusty conditions, a laser rangefinder may identify, based on sending out a signal, multiple reflective objects due to the sent signal reflecting off both a target object (that the laser rangefinder is aimed at) as well as interfering atmosphere (e.g., dust, fog, etc.) along the line of sight from the laser rangefinder to the target object. The reflections from interfering atmosphere could cause a laser rangefinder to incorrectly range the target object (e.g., may report the target object as closer than it actually is, due to the interfering atmospheric conditions). In a “last target” ranging mode of operation, also called “fog mode”, to compensate any interfering atmosphere, the laser rangefinder may seek out the furthest object, and determine range to the target object based on signal reflections from the furthest object. In some implementations, seeking out the furthest object may include emitting at maximum laser power, or employing some other high laser power setting to obtain an accurate range determination for the target object in the dusty/foggy conditions.
General ranging mode of operation—in this ranging mode of operation (which may be called “normal” ranging mode of operation, and which may be a default ranging mode of operation), the laser rangefinder may emit at less than the maximum laser power setting and/or less than the high power setting. In some implementations, this may include emitting at a dynamically determined laser power (e.g., a modular laser power, which may be up to maximum laser power in some implementations). In some implementations, a photo diode may be used to provide feedback to drive the power level of the dynamically determined laser lower. For instance, when the photo diode is saturated due to large return signal, the laser rangefinder may modulate the laser power down until the laser diode is no longer in the saturated condition, to improve ranging accuracy.
Other ranging modes of operation where the power level may be determined differently than the general ranging mode of operation. One example is a “dark mode,” which may lower the laser power when used indoors or at night.

When the laser rangefinder is set to a ranging mode of operation that is not appropriate for the current environmental conditions, for instance still set to the last target ranging mode of operation after the fog has lifted, the laser rangefinder may not perform optimal, because the general ranging mode of operation may use a different laser power than the last target ranging mode of operation.

In some known laser rangefinders, the operator of the laser rangefinder may be required to judge which ranging mode of operation is optimal for current environmental conditions. This judgement involves the operator's knowledge/skill, besides human senses. For example, a user may evaluate, with their eyesight, a time that fog has sufficiently set in (or lifted) in order to conclude whether a last target ranging mode of operation or a general ranging mode of operation is currently optimal for the laser rangefinder.

A requirement on the operator to make a manual assessment/conclusion as to which ranging mode of operation is most optimal for current conditions may lead to an inappropriately set laser rangefinder. For instance, an operator having insufficient knowledge/skill about the various different ranging modes of operation of the laser rangefinder and/or judging environmental conditions. Today, if an operator does not read the instructions or documentation, the operator may not even realize that they have a laser rangefinder set in last target ranging mode of operation, or that they need to change the ranging mode of operation once environmental conditions change (for instance when the fog lifts).

Operators also simply have different abilities with regard to their own human senses. In some instances an operator with less than perfect eyesight may have to simply take more time to properly judge whether a condition of the environment coincides with last target ranging mode of operation, as compared to an operator with perfect eyesight, for example. Given this, even when the operator makes the correct judgement, the time required to make the correct judgement may be undesirable for some applications. When under time pressure to evaluate which ranging mode of operation is optimal given current environmental conditions, such as when hunting, an animal could move away in the time that the operator may spend making the judgement about the ranging mode of operation.

Also, some known laser rangefinders may require the operator to watch a display of a laser rangefinder while operating the user input interface to change ranging modes of operation. If a game animal is present, even a knowledgeable/skilled operator may be distracted by the user interface operations that may be required to range the animal using the optimal ranging mode of operation. An inexperienced operator may lose sight of the game animal while attempting to operate the user interface, or possibly alert the game animal to the operator's presence.

In various embodiments, a laser rangefinder may include circuitry (e.g., a processor and memory) to 1) make an evaluation of environmental conditions, and 2) determine whether a currently set ranging mode of operation of the laser rangefinder coincides with the evaluation, or not. In various embodiments, the laser rangefinder may be configurable to 1) alert the operator when a currently set ranging mode of operation does not coincide with the evaluation and/or 2) automatically set the laser rangefinder to the coinciding ranging mode of operation.

The evaluation by the circuitry may be made using information collected from at least one sensor (e.g., an environmental sensor). In some example, the environmental sensor may include a sensor to characterize one or more attributes of the atmosphere, such as a sensor configured to measure:
Temperature;
Humidity; and/or
Atmospheric Pressure

While some embodiments may be configured to measure one or more attributes of the atmosphere (e.g., temperature, humidity, pressure, or the like, or combinations thereof), other embodiments may utilize a sensor configured to determine some other attribute of the environment. The at least one sensor may include an onboard sensor of the laser rangefinder, a sensor accessible by an external interface of the laser rangefinder (such as a sensor of nearby electronic device accessed via, say, a wireless connection), or combinations thereof.

In other examples, the evaluation by the circuitry may be made using information obtained via any online resources, now known or later developed. Online resources may include the cloud, a server accessible via the Internet, an application installed by the operator on another one of their computing devices, or the like, or combinations thereof. In yet further examples, the evaluation by the circuitry may be made using a combination of information collected from at least one sensor and information obtained from one or more online resources.

In any embodiment, the laser rangefinder may include circuitry to monitor the obtained information to detect an exception, such as when a current ranging mode of operation does not coincide with current environmental conditions. When the exception is detected, the circuitry may perform triggered action(s), such as automatically changing to a different ranging mode of operation, notifying the operator of the exception and/or providing a recommendation, modifying monitoring, or the like, or combinations thereof.

In one embodiment in which the obtained information is collected from at least one sensor, the circuity may monitor an onboard or nearby environmental sensor to detect when an attribute of the atmosphere is at a threshold (e.g., dewpoint). When the threshold reading is detected, the circuity may automatically switch the laser rangefinder to last target ranging mode of operation (or some other ranging mode of operation optimized for threshold precipitation in the ambient air).

In other embodiments, the circuitry may monitor sensor data collected by any sensor, now known or later developed, capable of detecting a threshold environmental condition. For example, in one embodiment, the sensor(s) may include a camera. In the example with the camera, the circuitry may detect a threshold condition (such as fog) via image analysis.

In various embodiments, a laser rangefinder may include one or more onboard environmental sensors to detect when atmosphere coincides with a threshold, such as the dew point. When the atmosphere does coincide with the threshold, the laser rangefinder may automatically switch from a general ranging mode of operation to a specialized ranging mode of operation such as fog mode.

In an alternative approach, the detection of the atmosphere non-coinciding with the threshold may trigger a different predefined action such as adjusting a signal processing algorithm utilized in a current ranging mode of operation. For example, detection of threshold lighting (using a light sensor) may trigger an adjustment to noise filters when ambient light levels are high. In another example, a thermal sensor may trigger the laser rangefinder to return a range only when the aiming point of the laser rangefinder is aligned to a warm body, to select game animals over the background.

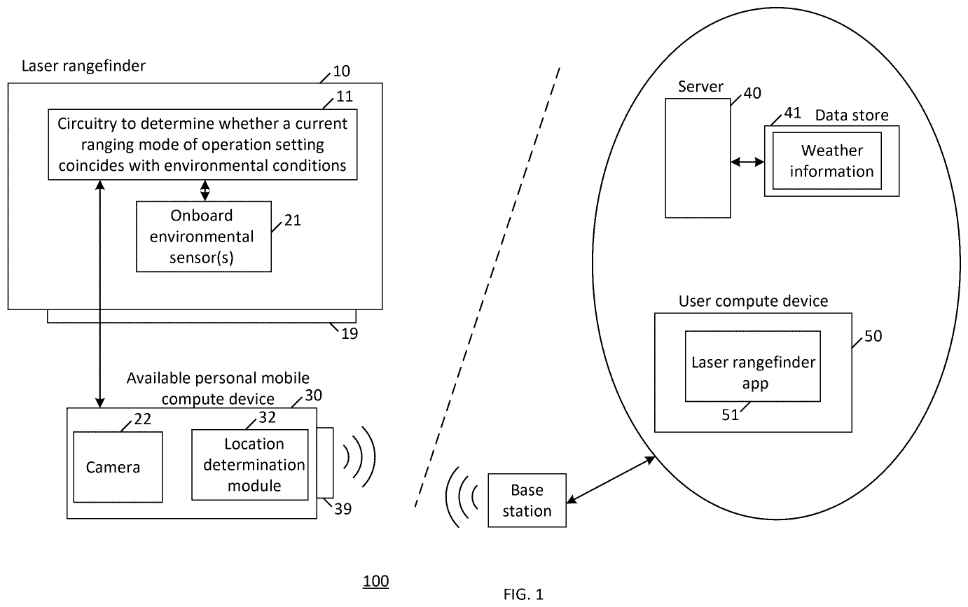

FIG. 1 is a schematic diagram of a system 100 including a laser rangefinder 10 with automatic ranging mode features, according to various embodiments. The laser rangefinder 10 may include circuitry 11 to determine whether a current ranging mode of operation setting coincides with environmental conditions.

The circuitry 11 may obtain information indicative of a current environmental condition corresponding to the laser rangefinder 10 (e.g., a current condition of an environment the laser rangefinder 10 operates in). This information may be obtained from one or more onboard sensors of the laser rangefinder 10, such as environmental sensor(s) 21, and/or from an external interface 19 of the laser rangefinder 10.

The onboard sensor(s) 21 may include any sensor(s) or sensor array, now known or later developed, and information obtained from these onboard sensor(s) or sensor arrays may include raw sensor data, or derived data. Derived data may be data derived from raw sensor data (derived data may be produced by one or more compute resources of a sensor array, in some embodiments).

The external interface 19 may include any communication circuitry now known or later developed, such as a short range wireless transceiver (such as a Bluetooth® transceiver), a wired interface, a long range wireless transceiver, or the like, or combinations thereof. The external interface 19 may enable communication between the circuitry 11 onboard the laser rangefinder 10 and a remote sensor, sensor array, processor, or the like, or combinations thereof.

A remote sensor may be part of one or more sensor devices capable of determining environmental conditions in a geographical location coinciding with a current or expected position of the laser rangefinder 10, and providing information about the determined environmental conditions to a remote device. These one or more sensor devices may include sensor(s) onboard an available mobile compute device 30, which may be an operator's a personal portable device such as a smartphone or any other compute device now known or later developed, in some examples. In this example, the sensor onboard the available mobile compute device 30 may be a camera 22 or some other imaging device, but in other examples it may be any other sensor now known or later developed. The one or more sensor devices may alternatively include an application specific sensor device such as a solar-powered sensor device with an external interface capable of communicating with an external interface 19 of the laser rangefinder 10.

In some embodiments, the external interface 19 may have different capabilities than an external interface 39 of the available mobile compute device 30. For example, an available mobile compute device may have cellular communication capability, satellite communication capability, or the like, or combinations thereof, which may be a different communication capability than the laser rangefinder 10. In these examples, the circuitry 11 may communicate with any communication network, such as the Internet or a cloud, through the external interface 39 of the mobile compute device 30. In some embodiments, the mobile compute device 30 may have an application configured to download data from the communication network using its external interface 39, and then transmit the downloaded data to circuitry 11 via the laser rangefinder's external interface 19.

Data from the communication network may include weather information, which may be part of a datastore 41 accessible to a server 40. In some examples, the circuitry 11 and/or an application on the mobile compute device 30 may infer a geographic region of the laser rangefinder 10 based on a location of the mobile compute device 30, determined using, for example, a subsystem 32 of the mobile compute device 30 and configured to determine location. For instance, an inferred geographic region of the laser rangefinder 10 may be a circle, centered on the mobile compute device's location, with a size (e.g., radius) based on a maximum communication range of the corresponding communication interface coupling the laser rangefinder 10 and the mobile compute device 30 (for example, a maximum range of the underlying short range wireless connection). In other examples, a location of the mobile compute device 30 may be determined by any other process, now known (such as triangulation based on base station accesses), or later developed. In other embodiments, the laser rangefinder's inferred location may simply be the location of the mobile compute device 30. In yet other embodiments, instead of inferring a location of the laser rangefinder 10 based on a location of the mobile compute device 30, the laser rangefinder 10 may include an onboard subsystem that is configured to determine location, in order to determine to the laser rangefinder's location.

In various embodiments, it may be possible to determine local weather information without using a measured location of one of the devices. For instance, an operator may install a laser rangefinder application 51 on a user compute device 50 (such as a desktop compute device), or alternatively on any other device in the system 100. The laser rangefinder application 51 may be given access to an electronic calendar, a trip planning service/application, or some other electronic resource associated with the operator of the laser rangefinder 10. The laser rangefinder application 51 may use a planned location indicated by the electronic resource(s) to determine a planned location of the laser rangefinder 10, and use this planned location to obtain the weather information indicative of the environmental condition, so that the circuitry 11 may set the ranging mode of operation based on environmental conditions.

Any other way to obtain forecasted or current environmental conditions of a measured or planned location of the laser rangefinder 10 may be used in various embodiments. In various embodiments, there may be a predefined ranking of ways to obtain the forecasted or current environmental conditions of a measured or planned location of the laser rangefinder 10. For example, sensor measurements may be a highest ranked way, and if the sensor measurements cannot be obtained the circuitry 11 may fall back to a next ranked way (such as an electronic calendar, trip planner, or other electronic resource that may not require sensors).

In various embodiments, the circuitry 11 may be implemented using application-specific processing elements (e.g., an application specific integrated circuit) and/or general purpose processing elements (e.g., a central processing unit). In examples using a general purpose processing element, the circuitry 11 may include a memory storing instructions that, when executed by the general purpose processing element, perform any operations described herein, including but not limited to operations of the circuitry 11 and/or operations of the system 100.

In the illustrated example, the circuitry 11 is not distributed (e.g., it is on a single device—the laser rangefinder 10). In other examples, a system similar in any respect to system 100 may include circuitry distributed between the laser rangefinder 10 and any other device of the system 100. As just one example, any operations described herein may be distributed between a processing component of the laser rangefinder 10 and a processing component of the mobile compute device 30, or a processing component coupled thereto (e.g., a cloud processing component). In another example, if the laser rangefinder 10 is memory/storage limited, a processing device onboard the laser rangefinder 10 could store data utilized by the circuitry 11 on a memory onboard the mobile compute device 30.

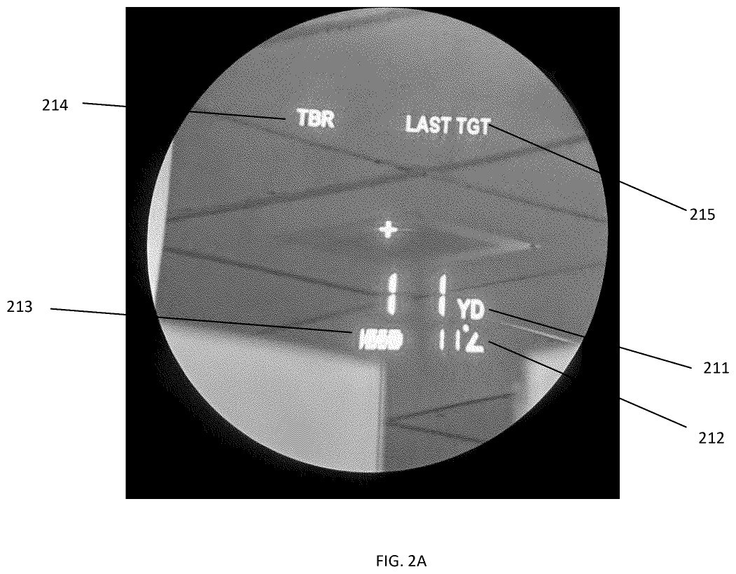

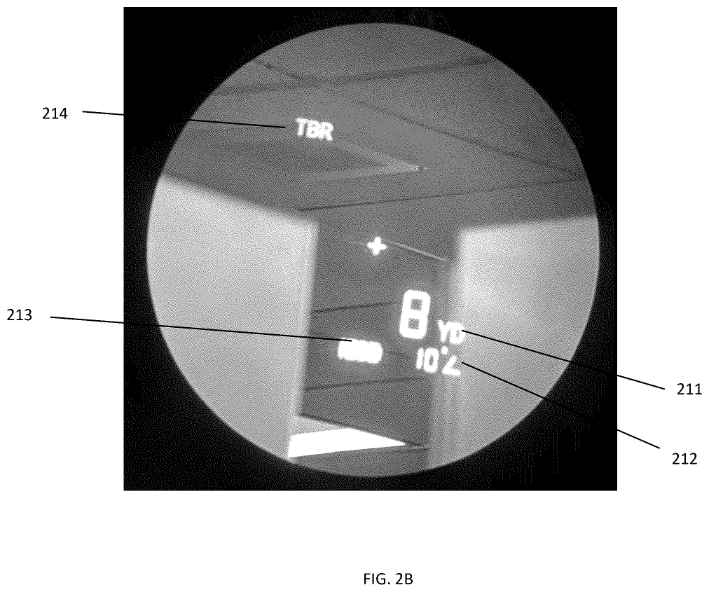

FIG. 2A is an example of a display provided by the laser rangefinder of FIG. 1, when a current ranging mode of operation of the laser rangefinder is set to a last target ranging mode. FIG. 2B is an example of a display provided by the laser rangefinder of FIG. 1, when a current ranging mode of operation of the laser rangefinder is set to a general ranging mode of operation.

Referring to FIG. 2A, in various embodiments, the laser rangefinder 10 may display a continuous indication 215 when the laser rangefinder 10 is set to non-general ranging modes of operation. Here, the continuous indication 215 is displayed continuously when in last target mode (last tgt). This continuous indication 215 may not be displayed in another ranging mode of operation, such as a general or other default ranging mode of operation. The display may include other continuously displayed components, such as the illustrated reticle, the range to target value 211, an incline/decline value 212, a battery indicator 213, and a True Ballistic Range® indicator 214, or the like, or combinations thereof.

An automatic ranging mode modification may occur as soon as a threshold change in the environmental conditions is detected, or may be queued to coincide with the operator looking through the laser rangefinder 10. In various embodiments, the circuitry 11 may display a temporary indication (such as a notification, not shown) for a short period of time following a time of execution of an automatic ranging mode modification. This notification may be displayed in a different location than the continuous indication, or may be displayed differently in the same location and/or using a different image in the same location. This may be the same notification displayed following an operator manually changing the ranging mode of operation, or may be a different notification. The duration of the period of time following an automatic ranging mode modification may be the same or different than a duration for a manual ranging mode modification.

Referring now to FIG. 2B, following the fog lifting, the circuitry 11 may automatically switch the laser rangefinder 10 back to a general ranging mode of operation. As illustrated, this display may omit the continuous indication 215 (FIG. 2A), because a lack of any continuous indication may signal to the operator that the laser rangefinder 10 is currently operating in the general ranging mode of operation. In various embodiments, the circuitry 11 may display a notification or other temporary indication (not shown) a period of time after the automatic switch of the ranging mode of operation.

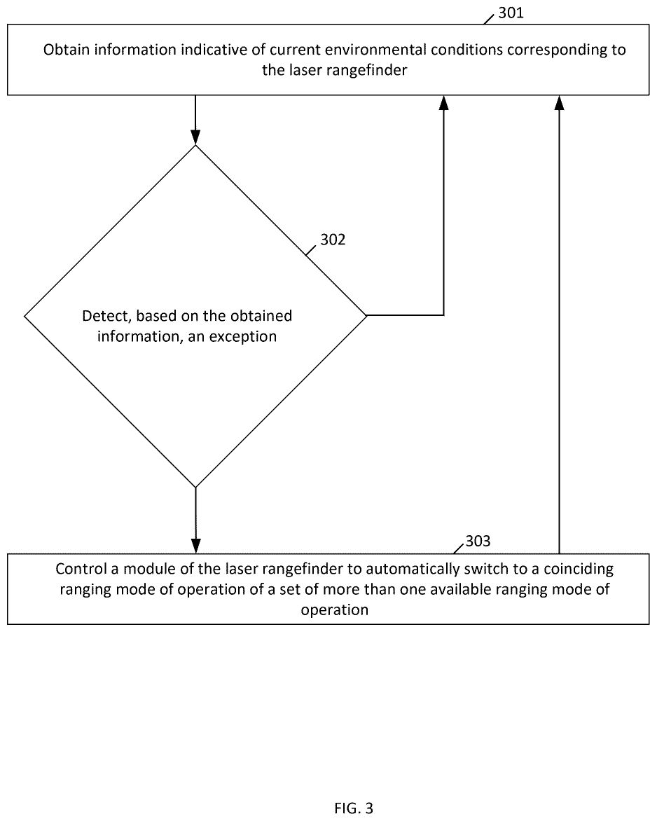

FIG. 3 is a flow chart illustrating operations that may be performed by any laser rangefinder described herein, according to various embodiments. The laser rangefinder may include at least an onboard module operable in more than one ranging mode of operation, to determine a range to a target in an environment, and circuitry to perform the operations described below. The onboard module may be similar to any known onboard module used in known laser rangefinders, now known or later developed.

In block 301, the laser rangefinder may obtain information indicative of current environmental conditions corresponding to the laser rangefinder. The obtained information may be based on raw sensor data, or may be derived from raw sensor data. Such data may be obtained from an onboard sensor of the laser rangefinder, or obtained over an external interface of the laser rangefinder (e.g., may originate from a nearby compute device, a nearby sensor device, a remote compute device, a remote sensor device, or the like, or combinations thereof). Also, such data may be a most recent sensor reading of the relevant sensor or sensor device, or may be a predicted value based on past sensor reading(s) and an expected or actual location of the laser rangefinder.

In diamond 302, the laser rangefinder may detect, based on the obtained information, an exception, in which a currently active ranging mode of operation of the laser rangefinder is non-coinciding with the obtained information. Examples of non-coinciding conditions may be fog thickness greater than a threshold, dust particles in the air greater than a threshold, or the like, or combinations thereof.

In block 303, the laser rangefinder may control the onboard module of the laser rangefinder to automatically switch to a coinciding ranging mode of operation of a set of more than one available ranging mode of operation. The automatic switch may occur immediately after detecting the exception, or may be deferred some amount of time to coincide with an operator viewing a display of the laser rangefinder. In various embodiments, the laser rangefinder may request approval from an operator to allow the automatic switching before proceeding to the automatic switching. This may be based on user settings (an operator may program the laser rangefinder to perform automatic switching without requesting approval or to request approval to perform the automatic switching). In various embodiments, approval to perform an automatic switching may require a different user input than a user input needed to perform a manual user interface modification (the manual user interface modification may utilize more than one user interface actuation, such as to navigate through options whereas an approve may require a different user interface actuation—a minimal user input, such as a single button press or other single user input).

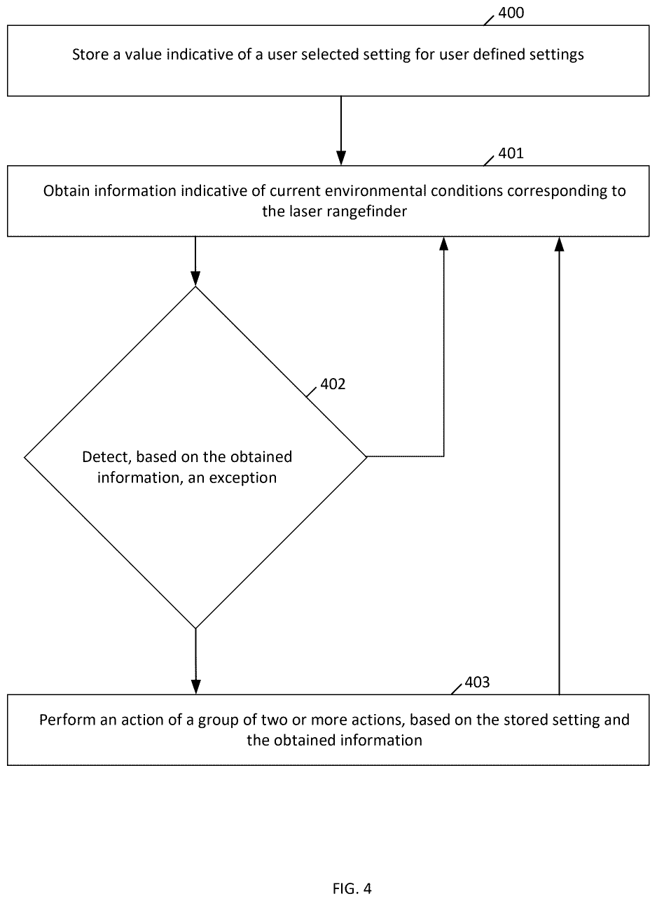

FIG. 4 is a flow chart illustrating operations that may be performed by any laser rangefinder described herein, according to various embodiments. In block 400, the laser rangefinder may store a value indicative of a user selection of user defined settings. For example, the operator may provide pre-approval for automatic switching for the laser rangefinder occurring in a user specified date and/or time range. In another example, the operator may provide preapproval for all automatic switching. In another embodiments, the threshold used by the laser rangefinder to determine when to automatically switch to a particular ranging mode of operation may be user defined in block 400.

Block 401 and diamond 402 may be similar in any respect to block 301 and diamond 302, respectively (FIG. 3). In block 403, the laser rangefinder may perform an action of a group of two or more predefined actions, based on a user defined setting and the obtained information.

The action of the one or more predefined actions may be specified in the user input from block 400. For example, if a user required an approval to proceed with an automatic switching via a user input in block 400, then in block 403 the laser rangefinder may request approval before proceeding with the switch.

In yet other embodiments, a user input in block 400 may lead to the predefined action in block 403 being a recommendation of a different ranging mode of operation, instead of the current ranging mode of operation, rather than a request for approval to automatically switch ranging modes of operation. In one example, the laser rangefinder may briefly display (e.g., flash once, or repeatedly during a time period) an indication having the same content as continuation indication 215 (FIG. 2A) or any other indication described herein. For instance, in response to a determination in diamond 402 that the environment may be foggy and the laser rangefinder may not be currently operating in the last target mode (fog mode), the laser rangefinder may briefly display the content of 215 (e.g., “LAST TGT”). The laser rangefinder may be configured to allow a user to perform a manual user interface modification to enable the recommended ranging mode of operation with a limited user input such as a minimal user input (e.g., a single button press of the power button, or some other button, within a threshold amount of time from initiation of the brief display, e.g., during a window of three seconds starting from initiating the brief display, during the time period of the brief display, etc.)

The user input to follow a recommendation to switch ranging modes of operation may be a minimal user input. The term “minimal user input” is used herein to mean that a user input that is different than a user input required to change a current ranging mode of operation without a recommendation. For instance, to change a current ranging mode of operation without a recommendation, a user may need to navigate, through say a menu, to their desired ranging mode of operation. Once the user has navigated to the desired ranging mode of operation, the user may have to make additional user input to enable that ranging mode of operation. The minimal user input required following a recommendation may not require the navigation—for instance it may require only a single button press (or other user input) during a predefined window of time (such as a fixed or user-configuration amount of time coinciding with the initiation of the displayed recommendation).

In the illustrated embodiment of FIG. 4, a user defined setting may control the recommendation behavior. However, this may not be required in other embodiments. In other embodiments, it may be possible to provide a laser rangefinder that automatically makes recommendations to a user, to perform a user input to modify the current ranging modes of operation using a minimal user input. For instance, in some embodiments, a laser rangefinder may perform blocks 301 and 302 (FIG. 3), and then instead of performing block 303 (automatic switching), display the recommendation to allow a manual user interface modification using a minimal user input. In these embodiments, if the user does not make the manual input, the laser rangefinder may return to block 301 and then monitor for a new exception (or for the same exception following a recommendation cooldown).

Any features described herein may be used with a laser rangefinder including an integrated viewable optical channel or a laser rangefinder usable with a viewable optical channel of an optic device or assembly associated therewith. Referring again to FIG. 1, the laser rangefinder 10 includes an integrated viewable optical channel. However, this is not required. Some laser rangefinders without a viewable optical channel may be mounted to an optic sight (e.g., a scope) or other part of a firearm assembly. A user may utilize the viewable optical channel of the scope to aim the mounted laser rangefinder. The laser rangefinder without the viewable optical channel may an output interface such as an LCD display. This output interface may be used to display indicators similar to any indicators described herein, including but not limited to any indicator described with reference to FIGS. 2A and 2B.

In any of the ranging modes of operation described herein, a laser rangefinder may measure background noise using a photo diode prior to identifying possible target(s). This may be performed by initialing evaluating a signal from the photo diode, prior to emitting the laser(s), and then evaluating a next signal from the photo diode concurrent with emitting. A difference between the background noise and a value associated with the next signal may be used to modulate the laser power level, and then possible target(s) may be identified at the modulated power level.

In some embodiments, it may be possible and practical to utilize motion sensor(s) instead of, or in addition to, a photo diode. In one example, if a threshold motion is detected, an operation of a ranging attempt may be modified (e.g., restarting a range if too much motion is detected). In another example, the laser rangefinder may automatically drop into a “shake” ranging mode of operation in which a longer duration range(s) are performed to ‘average in’ data from various orientations responsive to detection of the threshold motion.

It will be obvious to those having skill in the art that many changes may be made to the details of the above-described embodiments without departing from the underlying principles of the invention. The scope of the present invention should, therefore, be determined only by the following claims.

1. A laser rangefinder including:
a module operable in more than one ranging mode of operation, to determine a range to a target in an environment, wherein ranging modes of operation of the more than one ranging mode of operation are user-selectable, and the laser rangefinder includes a user interface to allow an operator to manually select amongst the user-selectable ranging modes of operation; and
circuitry configured to:
obtain information indicative of a current environmental condition corresponding to the laser rangefinder;
detect, based on the obtained information, an exception, wherein the exception comprises a current ranging mode of operation of the user-selectable ranging modes of operation being non-coincident with the current environmental condition; and
control the module to automatically switch to a coinciding ranging mode of operation of the user-selectable ranging modes of operation.

2. The laser rangefinder of claim 1, further comprising:
at least one onboard sensor, or
an external interface to communicate with at least one external sensor;
wherein the obtained information is collected by the at least one onboard sensor or the at least one external sensor.

3. The laser rangefinder of claim 2, wherein at least part of the obtained information is received via the external interface, and wherein the at least part of the obtained information originates from a nearby or remote sensor.

4. The laser rangefinder of claim 1, wherein at least part of the obtained information originates from an onboard sensor, a nearby sensor, a remote sensor, a weather meter, or a cloud or another electronic network.

5. The laser rangefinder of claim 1, wherein detect the exception comprises compare the current environmental condition to a threshold.

6. The laser rangefinder of claim 5, wherein the threshold is identified using information received over an external interface of the laser rangefinder.

7. The laser rangefinder of claim 1, further including an onboard sensor array or a single onboard sensor, wherein at least part of the obtained information originates from the onboard sensor array or the single onboard sensor.

8. The laser rangefinder of claim 7, wherein the onboard sensor array or the single onboard sensor is configured to measure temperature, pressure, or humidity.

9. The laser rangefinder of claim 7, wherein the onboard sensor array or the single onboard sensor includes a particle sensor.

10. The laser rangefinder of claim 7, wherein the on onboard sensor array or the single onboard sensor includes a light sensor.

11. A laser rangefinder including an onboard sensor array or another onboard sensor, or an external interface to access a remote sensor array or another remote sensor, the onboard sensor array or the other onboard sensor, or remote sensor array or the other remote sensor, is configured to measure temperature, humidity, or pressure, the laser rangefinder comprising:
a module operable in ranging modes of operation, to determine a range to a target in an environment; and
circuitry configured to:
obtain information indicative of a current environmental condition corresponding to the laser rangefinder, wherein at least part of the obtained information originates from the onboard sensor array or the other onboard sensor, or the remote sensor array or the other remote sensor;
detect, based on the obtained information, an exception, wherein the exception comprises a current ranging mode of operation of the ranging modes of operation being non-coincident with the current environmental condition; and
control the module to:
automatically switch to a coinciding ranging mode of operation of the ranging modes of operation, or
output, via a display of the laser rangefinder, a recommendation for a manual control of the laser rangefinder, using a predefined minimal user input to the laser rangefinder, wherein the laser rangefinder is configured to switch to the coinciding ranging mode of operation in response to said predefined minimal user input.

12. The laser rangefinder of claim 11, wherein at least part of the obtained information originates from a nearby sensor, a remote sensor, a weather meter, or a cloud or another electronic network.

13. The laser rangefinder of claim 11, wherein the detect the exception comprises comparing the current environmental condition to a threshold.

14. The laser rangefinder of claim 13, wherein the threshold is identified using information received over the external interface.

15. The laser rangefinder of claim 13, wherein the ranging modes of operation includes a ranging mode of operation optimized for threshold precipitation in the ambient air and at least one additional ranging mode of operation.

16. The laser rangefinder of claim 15, wherein the at least one additional ranging mode of operation includes, at least, a general ranging mode of operation.

17. An apparatus, comprising:
a laser emitter operable to emit at less than maximum laser power in a default mode of operation, the laser emitter further operable to emit at the maximum laser power in a non-default mode of operation;
circuitry configured to:
obtain information indicative of whether a current environmental condition, in which the laser emitter is expected to operate, is greater than a threshold, or not;
detect, based on the obtained information, an exception, wherein the exception comprises:
the laser emitter configured to emit at the less than maximum laser power, in a case that the current environmental condition is greater than the threshold, or
the laser emitter configured to emit at the maximum laser power, in a case that the current environmental condition is not greater than the threshold;
the circuitry further configured to, in a case of the exception, re-configure the laser emitter, in which the re-configured the laser emitter operates at:
the maximum laser power, in the case that the current environmental condition is greater than the threshold, or
the less than maximum power, in the case that the current environmental condition is not greater than the threshold.

18. The apparatus of claim 17, wherein the circuitry is settable by software, by a user, to, in the case of the exception, output an indication to obtain approval to complete the re-configuration, and perform the re-configuration upon receipt of a predefined minimal user input approving the re-configuration.

19. The apparatus of claim 17, wherein the circuitry is settable by software, by a user, to, in the case of the exception, complete the re-configuration in a fully autonomous manner.
